(19) United States
(12) Patent Application Publication
(10) Pub. No.: US 2018/0020070 A1
(43) Pub. Date: Jan. 18, 2018

(54) ONSITE DISPLAY IN A LOCATION-BASED MESSAGING PLATFORM

(71) Applicant: Quippy, Inc., San Jose, CA (US)

(72) Inventor: Alireza Jazayeri, San Jose, CA (US)

(21) Appl. No.: 15/640,332

(22) Filed: Jun. 30, 2017

Related U.S. Application Data
(60) Provisional application No. 62/356,530, filed on Jun. 30, 2016.
(60) Provisional application No. 62/356,531, filed on Jun. 30, 2016.
(60) Provisional application No. 62/356,532, filed on Jun. 30, 2016.
(60) Provisional application No. 62/356,533, filed on Jun. 30, 2016.

(51) Int. Cl. H04L 29/08; H04W 4/02

(52) U.S. Cl. CPC H04L 67/26; H04W 4/023

(57) ABSTRACT

Aspects of invention relate to a system architecture providing social media content to an onsite display. The system includes: the onsite display; a display stream services module configured to: provide a series of interfaces for display to an administrator of a venue location hosting the onsite display, the series of interfaces configured to obtain information from the administrator defining parameters of a stream for receiving and displaying social media content by the onsite display; a web server executing on a computer processor and configured to enable the computer processor to: using the parameters of the stream to configure a display stream generation engine to identify social media content from users in proximity to the onsite display; creating a connection with the onsite display to stream the social media content, the connection configured to push social media content to the onsite display; pushing, through the stream, content received from the users in proximity to the display and aggregated by the aggregation engine; and pushing engagement updates to the onsite display from other users in proximity to the display.

### CROSS-REFERENCE TO RELATED APPLICATIONS

This application claims benefit of U.S. Provisional Patent Application No. 62/356,530 (attorney docket #: quippy.00001.us.p.1), filed on Jun. 30, 2016 and entitled “CONTENT DELIVERY IN A LOCATION-BASED MESSAGING PLATFORM,” U.S. Provisional Patent Application No. 62/356,531 (attorney docket #: quippy.00001.us.p.2), filed on Jun. 30, 2016 and entitled “USER DISCOVERY IN A LOCATION-BASED MESSAGING PLATFORM,” U.S. Provisional Patent Application No. 62/356,532 (attorney docket #: quippy.00001.us.p.3), filed on Jun. 30, 2016 and entitled “ARBITRARY BADGING IN A SOCIAL NETWORK,” and U.S. Provisional Patent Application No. 62/356,533 (attorney docket #: quippy.00001.us.p.4), filed on Jun. 30, 2016 and entitled “ONSITE DISPLAY IN A LOCATION-BASED MESSAGING PLATFORM.” U.S. Provisional Patent Application Nos. 62/356,530, 62/356,531, 62/356,532, and 62/356,533 are incorporated by reference herein, in their entirety.

This application is related to the following copending U.S. patent applications: (1) U.S. patent application Ser. No. ______, entitled “CONTENT DELIVERY IN A LOCATION-BASED MESSAGING PLATFORM,” and filed on Jun. 30, 2017, (2) U.S. patent application Ser. No. ______, entitled “USER DISCOVERY IN A LOCATION-BASED MESSAGING PLATFORM,” and filed on Jun. 30, 2017, and (3) U.S. patent application Ser. No. ______, entitled “ARBITRARY BADGING IN A SOCIAL NETWORK,” and filed on Jun. 30, 2017. Copending U.S. patent application Ser. Nos. ______, ______, and ______ are incorporated by reference herein, in their entirety.

### BACKGROUND OF THE INVENTION

Hyperlocal and location-based social media platforms face unique challenges in identifying, aggregating, and delivering content. The majority of such platforms have historically targeted a consumer audience and have failed to generate the incentives necessary for a self-sustaining network effect. Many technical challenges associated with constraints of consumer clients and backend services have resulted in a lack of proliferation of location-based social platforms.

### BRIEF SUMMARY OF THE INVENTION

In general, in one aspect, the invention relates to a system for providing social media content to an onsite display. The system includes: the onsite display; a display stream services module configured to: provide a series of interfaces for display to an administrator of a venue location hosting the onsite display, the series of interfaces configured to obtain information from the administrator defining parameters of a stream for receiving and displaying social media content by the onsite display; a web server executing on a computer processor and configured to enable the computer processor to: using the parameters of the stream to configure a display stream generation engine to identify social media content from users in proximity to the onsite display; creating a connection with the onsite display to stream the social media content, the connection configured to push social media content to the onsite display; pushing, through the stream, content received from the users in proximity to the display and aggregated by the aggregation engine; and pushing engagement updates to the onsite display from other users in proximity to the display.

A method for providing social media content to an onsite display, comprising: providing a series of interfaces for display to an administrator of a venue location hosting the onsite display, the series of interfaces configured to obtain information from the administrator defining parameters of a stream for receiving and displaying social media content by the onsite display; using the parameters of the stream to configure a display stream generation engine to identify social media content from users in proximity to the onsite display; creating a connection with the onsite display to stream the social media content, the connection configured to push social media content to the onsite display; pushing, through the stream, content received from the users in proximity to the display and aggregated by the aggregation engine; and pushing engagement updates to the onsite display from other users in proximity to the display.

A non-transitory computer-readable storage medium comprising instructions for providing social media content to an onsite display, wherein the instructions, when executed on at least one computer processor, enable the computer processor to: provide a series of interfaces for display to an administrator of a venue location hosting the onsite display, the series of interfaces configured to obtain information from the administrator defining parameters of a stream for receiving and displaying social media content by the onsite display; use the parameters of the stream to configure a display stream generation engine to identify social media content from users in proximity to the onsite display; create a connection with the onsite display to stream the social media content, the connection configured to push social media content to the onsite display; push, through the stream, content received from the users in proximity to the display and aggregated by the aggregation engine; and push engagement updates to the onsite display from other users in proximity to the display.

Other aspects of the invention will be apparent from the following description and the appended claims.

### BRIEF DESCRIPTION OF THE DRAWINGS

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

Embodiments of the present invention are illustrated by way of example, and not by way of limitation, in the figures of the accompanying drawings and in which like reference numerals refer to similar elements.

FIGS. 1A and 1B show schematic diagrams of systems, in accordance with one or more embodiments of the invention.

FIGS. 2A-2C depict example user interfaces showing friends-only and merged (friends+nearby) streams, in accordance with one or more embodiments of the invention.

FIG. 3 depicts an example user interface displaying users nearby, in accordance with one or more embodiments of the invention.

FIGS. 4A-4I depict example user interfaces of a wizard for creating a stream configured for pushing content to an onsite display, in accordance with one or more embodiments of the invention.

### DETAILED DESCRIPTION OF THE INVENTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

In general, embodiments of the invention provide methods and systems related to location-based social networking systems and architecture.

Flashcast Display (i.e., Onsite Display):

In one or more embodiments, an onsite display can be configured to receive content from the social media platform for display to users at a venue location. The onsite display can be owned and operated by a venue partner or business customer of the social media platform. An owner or administrator of the venue can define the display according to the steps shown in FIGS. 8A-8I. These figures describe a self-service UI of the client application that allows users to define and launch their own onsite displays in exchange for periodic payment to the social media platform (or for free). Upon completion of the creation wizard depicted by FIGS. 8A-8I, the user is granted a URL of their newly created display stream. The user then configures their physical onsite display device, in one embodiment, using a built in web browser (eg, a smart TV), to display a web page referenced by the URL in full screen mode.

The web page dynamically cycles through a queue of content items posted to the social media platform by users of the platform who are nearby to the location of the physical display device (as defined by the venue admin). The maximum distance of a given content item to the display device can be variable, and is dependent on the depth of the region comprising the content item in the density based geohash tree (stored in the User Content Graph)

### Embodiment A: Entertainment Display

In this embodiment, the physical display device is installed in an entertainment venue and is designed to enable users to view their own content and to share that content on a second screen with other users in proximity to the venue. For example, a night club or concert hall may place one or more onsite display devices at their venue location in order to entertain and engage their audience. In one embodiment, the social media platform allows an administrator or representative of the venue to moderate the content displayed on the onsite display via the display stream served by the social media platform. Moderation options are shown in FIG. 8G. In one embodiment, the admin installs a specialized moderator client application which enables him to approve or deny posts that are queued for moderation by the platform. The moderator client application also includes functionality to receive promoted content items from the admin of the venue. The admin can upload and create a content item using the moderator client app, define a posting radius, broadcast time, demographic, and/or a variety of other details associated with the post. Furthermore, the admin can define specifics of the post relating to display on one or more of the onsite display streams of the venue.

The physical display device can also be configured by the admin, using the moderator client app, to pan/tilt/rotate or otherwise move according to pre-selected rules. A fixed display or a moveable display can be configured as such. For example, a robotic arm operatively connected to the physical display device can be utilized to perform said movement, or a drone operatively connected to the display device can stream the live video stream to be shown on the display device.

### Embodiment B: Advertising Display

In this embodiment, the physical display device is configured for advertising purposes. The device may be configured to display a call to action to users nearby. For example, a billboard may include text that says “Download Acme Social to post a picture of your Brand X sneakers to this display”. A moderator of the display can then curate and approve content posted by users within proximity of the display by selecting user content items including said “Brand X sneakers”. In one embodiment an automated approval module of the social media platform automatically detects photo or video content similar to content defined by an admin of the display stream. For example, a logo of Brand X may be automatically matched to user content including the logo such that the user content is automatically approved for display on the display device. Content not including the logo may be rejected or manually approved by the admin.

### Embodiment C: Retail Display

In this embodiment, the physical display device is installed at a retail location. The device may be configured to display content items depicting customers of the retail store wearing, using, and/or interacting with products and services of the retail store. For example, a fashion retailer may install the onsite display device outside of a dressing room of the retail store. Customers who try on clothing sold by the retailer can optionally upload content showing themselves wearing the clothing using the client app of the social media platform. In this way, the customer is given a platform for viewing themselves interacting with products and services of the retailer, and is able to share the experience and content they produce with (i) other customers onsite and (ii) remote customers viewing via the client app of the social media platform.

A content capture fixture can be installed by the retail store onsite. The content capture area can include (i) a location for customers to pose for media capture (eg, a booth) and (ii) a camera device operatively connected to the physical display device (eg, by a wireless interface). In this way, the content capture fixture can be utilized by customers of the retail store to generate and upload content to the social media application without the need for a personal mobile computing device. For example, a customer may enter the fixture and enter credentials of their account with the social media platform. Upon entering credentials, the customer may use the fixture to capture and upload video content to the platform. Upon approval by an administrator of the retail store, the content is then displayed on an onsite physical display device of the retail store for other customers to view. Customers can use their own mobile devices, using the mobile app of the social media platform, to comment or otherwise engage with the content. The social media platform may require customers to be within a predefined proximity of the retail store in order to interact with the content, or may highlight interactions by customers who are present over remote customer interactions.

1) User Streams: this is a repository that includes a data structure representing a stream of data for each user. This stream includes only data from friends and followed accounts initially. The Message Ingestion Service copies each message that is posted by a user into their followers/friends streams as they are posted. This is how the streams are updated in realtime as messages are “ingested” by the system. Nearby data is not added to the stream until it is requested by a user. In other words, if a user client requests their stream the Stream Generation Module fetches it from the User Streams Repo and then merges it with nearby data from the User Content Graph in realtime, then serves the merged data to the user client.

2) The clustering Engine: a distributed offline service that takes user content from the User Content Graph and groups that data into Hotspots. These hotspots, which are the output of the clustering process are stored in the Hotspots Repo.

The clustering engine begins by segmenting the clustering work geographically. Since the data in the User Content Graph is stored in a density-based geohash tree structure, the Clustering Engine can select leaf nodes of the tree (or select a fixed number of hops above the leaf nodes) in order to grab a quasi-fixed size chunk of data from a variable sized geographic region.

So some regions may be dramatically different in geographic size, but should represent some upper bound in terms of content size (i.e., number of content items).

Let's call the selected region R. The next thing that the Clustering Engine does is to grab leaf nodes of the density based geohash tree that cover the perimeter of region R.

These surrounding regions may also be of variable geographic size

Let's call the resulting region F=R (selected region)+N (neighboring regions). This resulting region F is passed to a worker service of an elastic computing cluster for analysis.

So the initial identification of the multiple F regions happens by a Master Clustering Service which then passes the F regions to multiple worker services. Each worker service performs the actual clustering on its respective region. The clustering we perform is fixed-radius clustering, but any type of clustering algorithm may be used. For example, K-means clustering or other types of clustering may be performed. Fixed radius clustering is preferred because it represents variable number of clusters of fixed (or semi-fixed) geographic size.

Once each worker completes clustering it returns the result of the clustering (a set of identified clusters) to the Master Clustering Service (MCS). The MCS the obtains the results from each worker and performs a deduplication. Deduplication means that if there are any 2 clusters that overlap, we delete the one with the lower density. Deduplication is necessary because the regions were deliberately selected to overlap, in order to prevent edge cases where a cluster overlaps two workers' regions. Since the regions overlap (by virtue of the fact that we selected perimeter neighbors), the cluster will be identified by at least 1 of the workers in full.

The MCS then stores the deduplicated results in the Hotspots Repo.

Again, the Clustering Engine includes the MCS and the workers, which are implemented in an elastic computing cluster.

The clustering engine performs the clustering and overwrites the data in the Hotspots repo periodically (eg, every 5 minutes). This way the clusters stay current and the data that is posted by users makes it into a cluster within at most 5 minutes of time (+clustering runtime).

The Hotspot Delivery module (HDM) obtains requests from clients, each request including a location of the client. The HDM then fetches a set of the hotspots from the Hotspot Repo that are closest to the client location. The Hotspots in the Hotspot Repo are also stored by their geohash value, and are also stored in a density-based geohash tree. This way, we can fetch hotspots only in the leaf node region of the tree (plus neighbors), order them by proximity to the client, and return a predefined number of them in response to the request.

3) The Social Graph Repo: this stores the relationships (both bi-directional and directed edges) between accounts. These represent followers, friends, or other types of relationships. This data is used by the Message Ingestions Service to create and store the streams (connect that edge also MIS<->Social Graph).

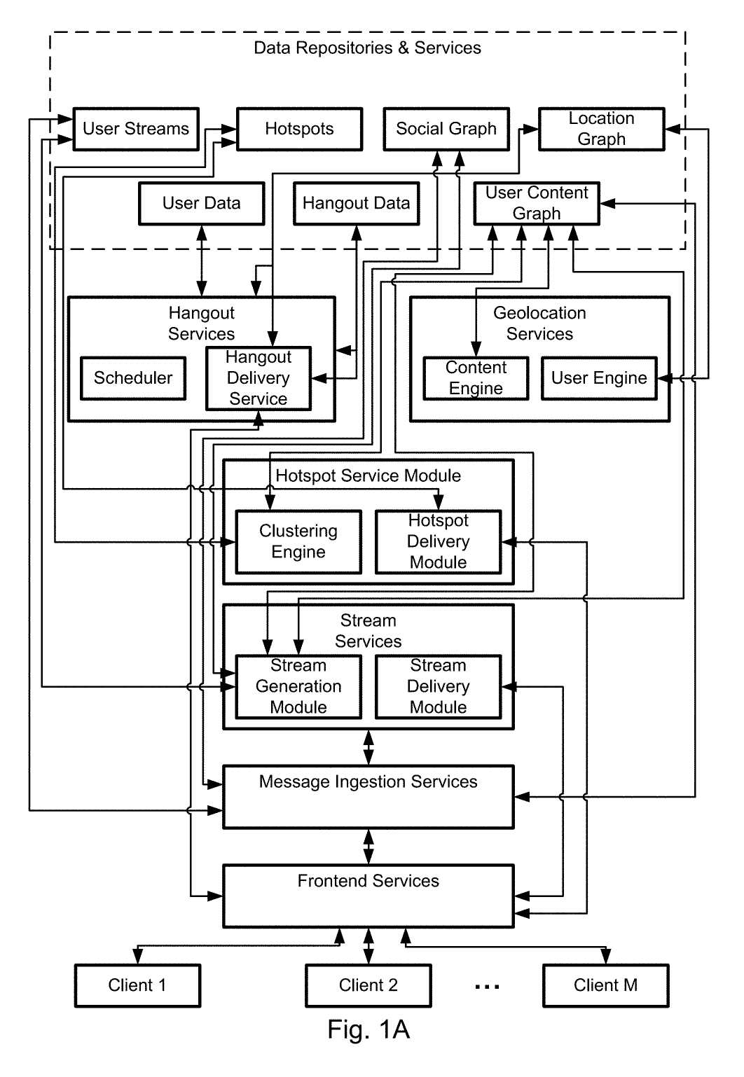

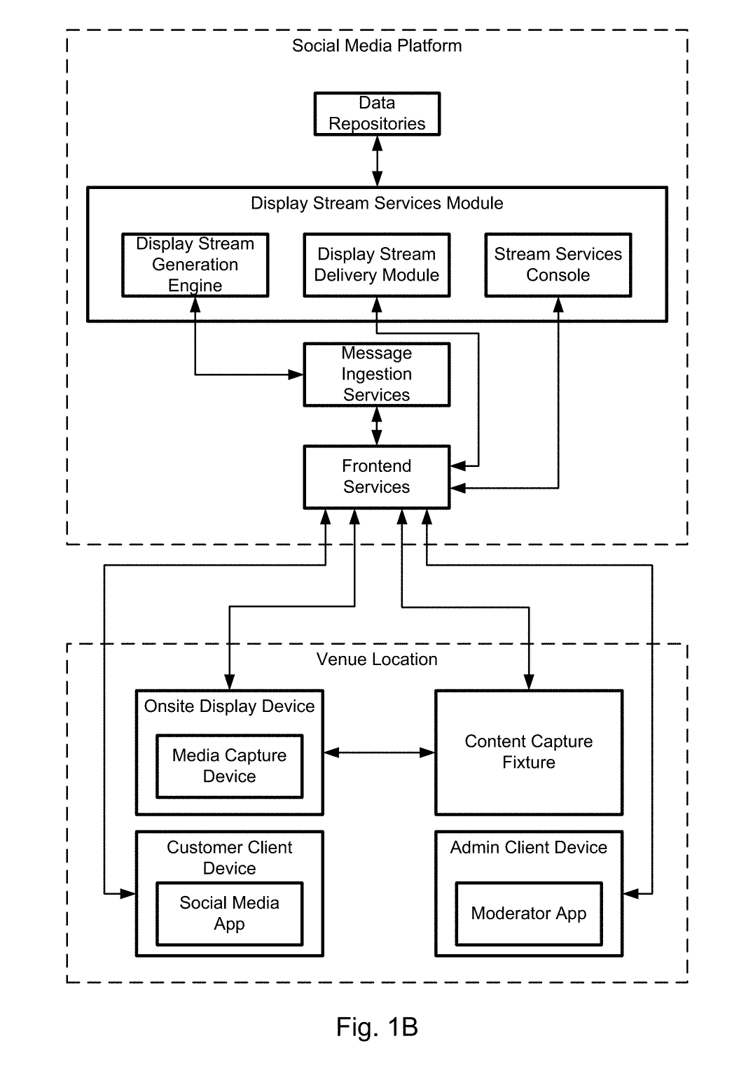

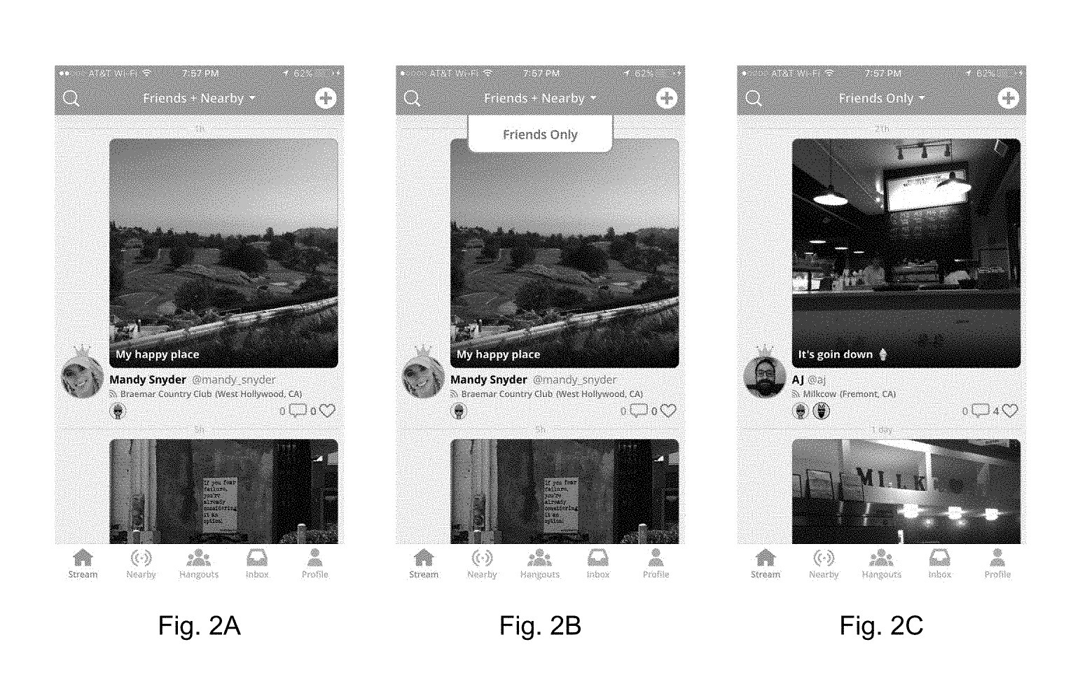

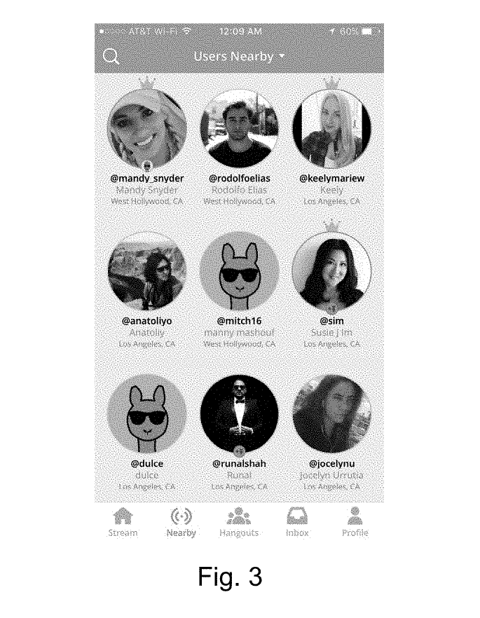

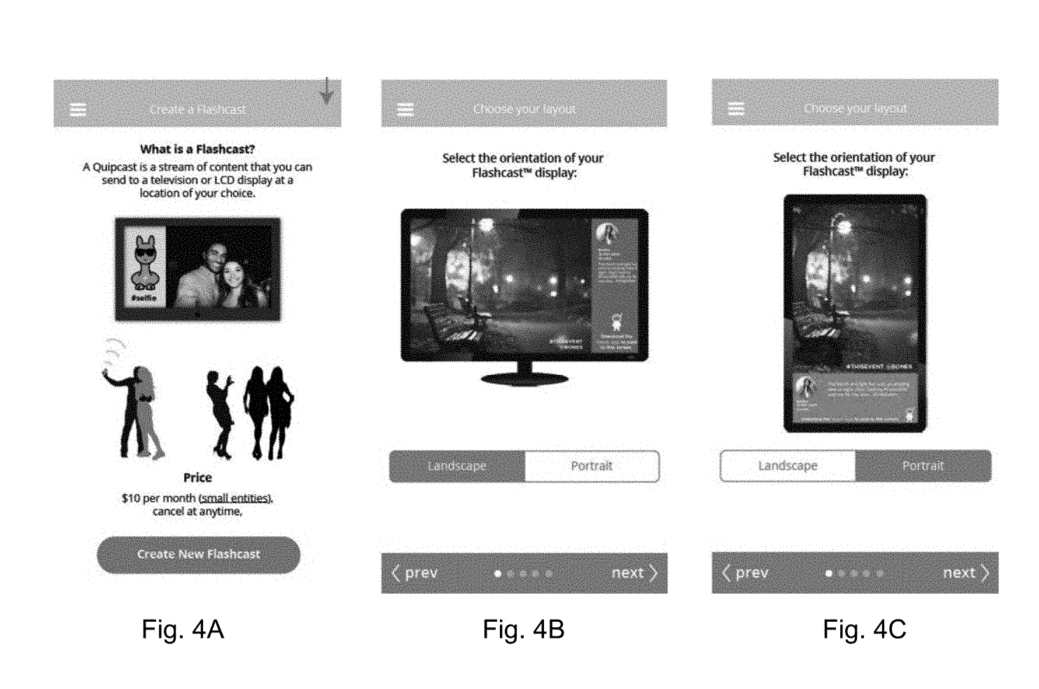

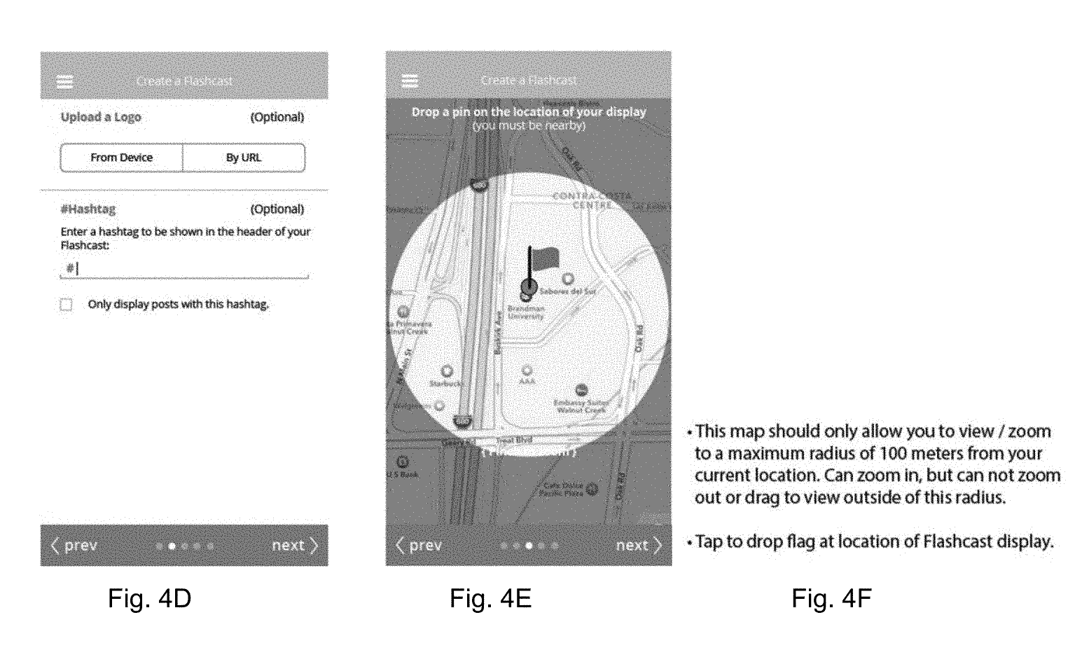

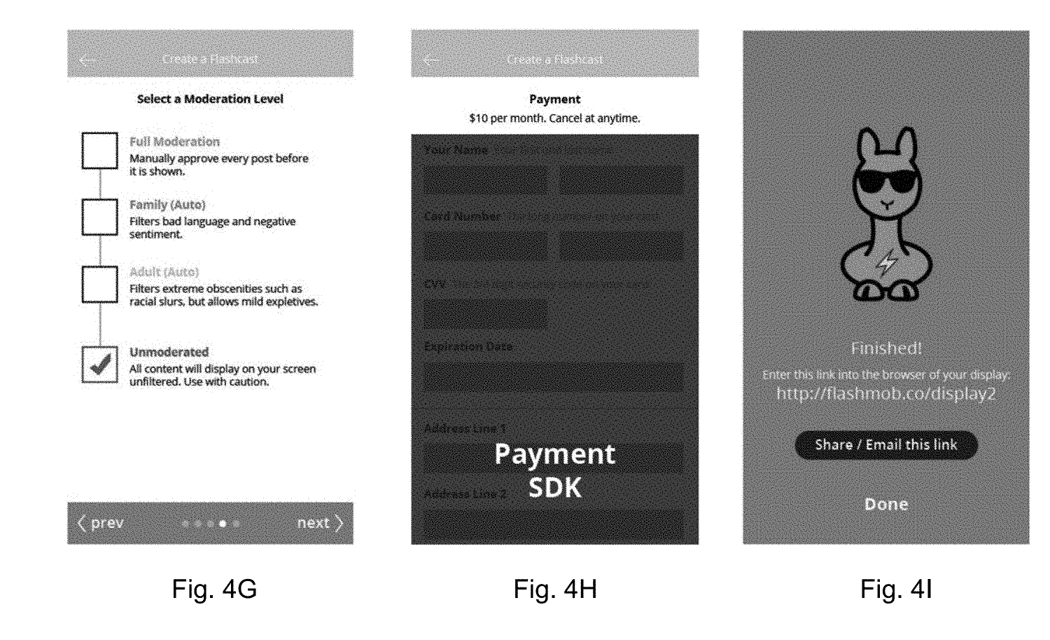

4) User Data simply stores the name, display name, and other account attributes of each user. Even though not shown, this data is used by most of the services of FIG. 1A.

5) Hangout Data Repo: this stores the details of each Hangout created by our users. Again, there may be other data repos within this repository that include necessary Hangout data.

6) Hangout Services: this is a collection of services that schedules, creates, modifies, and delivers hangouts in response to user requests. This includes a Scheduler which schedules Hangouts and generates notifications when users are invited, join, leave otherwise interact with hangouts.

Hangout Delivery Module fetches hangout information from both the Location Graph and the Hangout Data Repo and returns that data in response to client requests.

7) Location Graph Repo: this is one of the most important repositories in the system. This Repo stores objects representing the location of physical entities in a density based geohash tree structure. An object in the Location Graph can include: a user object representing the last known location of a user, a hangout object representing the location of a hangout, a venue object representing the location of a physical location (eg, a business, an event) and etc.

Each object can also include an effective date/time/duration representing when it is active. For example, once a hangout is over it would no longer be active.

Or, the timeouts for user objects would dictate how or when they are surfaced to other users (as described in the “live user discovery” algorithms).

Geolocation Services Module may periodically prune/remove stale data from the Location Graph Repo as desired.

Next topic will be how Hangout, user, and venue objects are stored in the Location Graph Repo and why that data needs to be duplicated.

So, let's start with user data in the Location Graph Repo. The Flashmob app on the user device has a background location monitoring engine (BGE) that uses the operating system API to track the user's location even when they aren't using the app. In iOS there are two methods of doing this: one is called significant location change and the other is region monitoring. Either can be used. The premise is that the BGE tracks the user's location and sends updates of the location to the Frontend Service which then relays the updates to the Geolocation Services Module. There is an object representing the user in the Location Graph Repo, and the User Engine of the Geolocation Services Module updates that user's location in the Repo. This location is stored as a geohash value. There is a Geohash Tree Engine (GTE) that is not shown, which balances all of the geohash trees and handles insertion, removal, and update of content in the tree. If the new geohash value changes from one leaf node of the density-based geohash tree to a different leaf node, the GTE performs a rebalance of the tree. The GTE performs this rebalance by basically leaving the old user object but marking it for removal (inactive) and just adding a new user object with the new geohash value. There is a periodic process which essentially “rebuilds” the geohash tree and prunes the old geohash values. In an alternate implementation, a recursive algorithm restructures the tree on-demand to maintain balance.

This maintenance of the density-based geohash tree (DBG tree), along with the GTE applies to all DBG trees in the system including the User Content Graph, and the Hotspots DBG tree in the Hotspots repo.

(although the Hotspots do not typically require insertion and removal with the exception of manual curation by and administrator, removal of NSFW content, regional blacklisting, etc)

Hangout objects in the Location Graph Repo are similarly stored. There are different consumption experiences in the client application that require different usages of this Repo. The main ones are: Nearby User Discovery, Hangouts Discovery, Venue Discovery, and hybrids of one or more of them. The term “live user discovery” can refer to any of the aforementioned and is not strictly limited to user objects. So, in nearby user discovery for example, the Geolocation Services Module gets a request to fetch nearby users for a client. The location of the client is used to identify a search region R (including perimeter neighbors), all active users in R are ordered by proximity to the client, and the closest X users (depending on requested page size) are returned to the client in response to the client request.

In the hybrid approach, a single view in the client application can display any of the three object types in the same result set, ordered by proximity to the client.

One important point about the DBG trees is that they include replicated data (for performance reasons). In other words, each DBG tree node includes all data required for its respective consumption experience. For example, user objects include username, display name, profile thumbnail URL, and a subset of other user attribute data that is already stored in the User Data Repo. Updates to the User Data Repo must therefore also be made to the Location Graph Repo and vice versa to maintain consistency. In this way, a single query to the Location Graph Repo can quickly fetch results with no external dependency.

Flashcast Algorithm

In one embodiment, the Flashcast will only display posts that originated within a predefined distance (eg, 500 meters) of the Flashcast display location. Anything farther away will never be shown.

The Flashcast will maintain a queue (Q) of predefined quantity of posts (eg, 20) to be rotated on the Flashcast display regularly.

As part of the message ingestion process, an asynchronous background thread is generated for each posted message (P)

This thread will identify all Flashcast displays within 500 m of the post (P) location. For example, for each display:

If Qsize<20: add the message to the top of Q

Else if Qsize=20:

(i) Score of the new post, Pscore=proximity from Flashcast display.

(ii) Q has a scoring timestamp that represents the time since the posts in Q were last scored/ranked. The scores of each post in Q are cached in Q. If scoring timestamp of Q<=30 seconds old: use cached scores of posts in Q

(iii) Else if scoring timestamp of Q>30 seconds: re-score Q using Score=A+0.69*B, where A is distance (meters) of the post from the Flashcast display and B=age of post (seconds). Reset scoring timestamp to current time.

(iv) Check scores of posts in Q to see if Pscore is lower than at least one of the posts in Q. If so, lock the lowest ranking post inside Q (lock prevents eviction of this post from Q by other threads). Evict this lowest ranking post and insert the new post at the top of Q (so it is the first post displayed by the Flashcast).

Notes: position in Q doesn't change based on rank of posts. In this example, new posts are always added immediately after current pointer. A failsafe exists to make sure the writer thread does not become bogged down when production is high.

For purposes of this disclosure, the terms messaging platform, social media platform, and social network may be used interchangeably.

Various system configurations: Although the components of the systems are depicted as being directly communicatively coupled to one another, this is not necessarily the case. For example, one or more of the components of the systems may be communicatively coupled via a distributed computing system, a cloud computing system, or a networked computer system communicating via the Internet.

Various system configurations: It should be appreciated that one computer system may represent many computer systems, arranged in a central or distributed fashion. For example, such computer systems may be organized as a central cloud and/or may be distributed geographically or logically to edges of a system such as a content delivery network or other arrangement. It is understood that virtually any number of intermediary networking devices, such as switches, routers, servers, etc., may be used to facilitate communication.

While the present disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. Some of the steps may be performed simultaneously. For example, in certain circumstances, multitasking and parallel processing may be advantageous. The various example methods described and/or illustrated herein may also omit one or more of the steps described or illustrated herein or include additional steps in addition to those disclosed.

Embodiments may be implemented on a specialized computer system. The specialized computing system can include one or more modified mobile devices (e.g., laptop computer, smart phone, personal digital assistant, tablet computer, or other mobile device), desktop computers, servers, blades in a server chassis, or any other type of computing device(s) that include at least the minimum processing power, memory, and input and output device(s) to perform one or more embodiments.

For example, a computing system may include one or more computer processor(s), associated memory (e.g., random access memory (RAM), cache memory, flash memory, etc.), one or more storage device(s) (e.g., a hard disk, an optical drive such as a compact disk (CD) drive or digital versatile disk (DVD) drive, a flash memory stick, etc.), a bus, and numerous other elements and functionalities. The computer processor(s) may be an integrated circuit for processing instructions. For example, the computer processor(s) may be one or more cores or micro-cores of a processor.

In one or more embodiments, the computer processor(s) may be an integrated circuit for processing instructions. For example, the computer processor(s) may be one or more cores or micro-cores of a processor. The computer processor(s) can implement/execute software modules stored by computing system, such as module(s) stored in memory or module(s) stored in storage. For example, one or more of the modules described in the figures can be stored in memory or storage, where they can be accessed and processed by the computer processor. In one or more embodiments, the computer processor(s) can be a special-purpose processor where software instructions are incorporated into the actual processor design.

The computing system may also include one or more input device(s), such as a touchscreen, keyboard, mouse, microphone, touchpad, electronic pen, or any other type of input device. Further, the computing system may include one or more output device(s), such as a screen (e.g., a liquid crystal display (LCD), a plasma display, touchscreen, cathode ray tube (CRT) monitor, projector, or other display device), a printer, external storage, or any other output device. The computing system may be connected to a network (e.g., a local area network (LAN), a wide area network (WAN) such as the Internet, mobile network, or any other type of network) via a network interface connection. The input and output device(s) may be locally or remotely connected (e.g., via the network) to the computer processor(s), memory, and storage device(s).

One or more elements of the aforementioned computing system may be located at a remote location and connected to the other elements over a network. Further, embodiments may be implemented on a distributed system having a plurality of nodes, where each portion may be located on a subset of nodes within the distributed system. In one embodiment, the node corresponds to a distinct computing device. Alternatively, the node may correspond to a computer processor with associated physical memory. The node may alternatively correspond to a computer processor or micro-core of a computer processor with shared memory and/or resources.

For example, one or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface.

One or more elements of the above-described systems may also be implemented using software modules that perform certain tasks. These software modules may include script, batch, routines, programs, objects, components, data structures, or other executable files that may be stored on a computer-readable storage medium or in a computing system. These software modules may configure a computing system to perform one or more of the example embodiments disclosed herein. The functionality of the software modules may be combined or distributed as desired in various embodiments. The computer readable program code can be stored, temporarily or permanently, on one or more non-transitory computer readable storage media. The non-transitory computer readable storage media are executable by one or more computer processors to perform the functionality of one or more components of the above-described systems and/or flowcharts. Examples of non-transitory computer-readable media can include, but are not limited to, compact discs (CDs), flash memory, solid state drives, random access memory (RAM), read only memory (ROM), electrically erasable programmable ROM (EEPROM), digital versatile disks (DVDs) or other optical storage, and any other computer-readable media excluding transitory, propagating signals.

It is understood that a “set” can include one or more elements. It is also understood that a “subset” of the set may be a set of which all the elements are contained in the set. In other words, the subset can include fewer elements than the set or all the elements of the set (i.e., the subset can be the same as the set).

While the invention has been described with respect to a limited number of embodiments, those skilled in the art, having benefit of this disclosure, will appreciate that other embodiments may be devised that do not depart from the scope of the invention as disclosed herein.

What is claimed is:

1. A system for providing social media content to an onsite display, comprising:
the onsite display;
a display stream services module configured to:
provide a series of interfaces for display to an administrator of a venue location hosting the onsite display, the series of interfaces configured to obtain information from the administrator defining parameters of a stream for receiving and displaying social media content by the onsite display;
a web server executing on a computer processor and configured to enable the computer processor to:
using the parameters of the stream to configure a display stream generation engine to identify social media content from users in proximity to the onsite display;
creating a connection with the onsite display to stream the social media content, the connection configured to push social media content to the onsite display;
pushing, through the stream, content received from the users in proximity to the display and aggregated by the aggregation engine; and
pushing engagement updates to the onsite display from other users in proximity to the display.

2. The system of claim 1, wherein the onsite display is a component of a billboard and wherein the social media content is related to an advertisement displayed concurrently on the billboard.

3. The system of claim 1, further comprising:
a content capture fixture connected to the onsite display and configured to:
capture media content of people at the onsite display;
generate additional social media content authored by an account associated with an entity hosting the onsite display;
provide the additional social media content to a display stream delivery module for pushing to the onsite display through the stream.

4. The system of claim 1, further comprising a content capture area where patrons of the entity hosting the onsite display can pose in proximity to the content capture fixture.

5. A method for providing social media content to an onsite display, comprising:
providing a series of interfaces for display to an administrator of a venue location hosting the onsite display, the series of interfaces configured to obtain information from the administrator defining parameters of a stream for receiving and displaying social media content by the onsite display;
using the parameters of the stream to configure a display stream generation engine to identify social media content from users in proximity to the onsite display;
creating a connection with the onsite display to stream the social media content, the connection configured to push social media content to the onsite display;
pushing, through the stream, content received from the users in proximity to the display and aggregated by the aggregation engine; and
pushing engagement updates to the onsite display from other users in proximity to the display.

6. A non-transitory computer-readable storage medium comprising instructions for providing advertising content, wherein the instructions, when executed on at least one computer processor, enable the computer processor to:
provide a series of interfaces for display to an administrator of a venue location hosting the onsite display, the series of interfaces configured to obtain information from the administrator defining parameters of a stream for receiving and displaying social media content by the onsite display;
use the parameters of the stream to configure a display stream generation engine to identify social media content from users in proximity to the onsite display;
create a connection with the onsite display to stream the social media content, the connection configured to push social media content to the onsite display;
push, through the stream, content received from the users in proximity to the display and aggregated by the aggregation engine; and
push engagement updates to the onsite display from other users in proximity to the display.
